(19) United States
(12) Patent Application Publication
(10) Pub. No.: US 2021/0053061 A1
(43) Pub. Date: Feb. 25, 2021

(54) INERTIAL CELL FOCUSING AND SORTING

(71) Applicant: SINGAPORE UNIVERSITY OF TECHNOLOGY AND DESIGN, Singapore (SG)

(72) Inventors: Ye AI, Singapore (SG); Yinning ZHOU, Singapore (SG)

(21) Appl. No.: 16/772,991

(22) PCT Filed: Dec. 14, 2018
(86) PCT No.: PCT/SG2018/050615

§ 371 Date: Jun. 15, 2020

(30) Foreign Application Priority Data
Dec. 15, 2017 (SG) 10201710457X

(51) Int. Cl. B01L 3/00; G01N 15/02

(52) U.S. Cl. CPC B01L 3/502761; B01L 3/502746; G01N 15/0255; B01L 2200/0652; G01N 2015/1006; B01L 2300/0864; B01L 2300/0883; B01L 2400/0487; B01L 2300/0816

(57) ABSTRACT

The present invention relates to the microfluidic sorting, separating and/or manipulation of particles, preferably circulating tumor cells (CTCs). In an aspect of the present invention, there is provided a device for sorting, separating or manipulating particles in a fluid suspension, the device comprising: (a) at least one inlet for introducing the fluid suspension; (b) at least one outlet for discharging the fluid suspension containing particles of a desired size; and (c) a channel in fluid communication with and intermediate the at least one inlet and the at least one outlet, a portion of the main channel is curved to form at least one curved unit, the curved unit is shaped to form a profile of a wave having a crest, a lip that curls over a trough, and a face, wherein the crest, lip, face and trough of the curved unit each forms a semicircular arc segment, the fluid suspension travels through the curved unit from the semicircular arc segment of the crest to the semicircular arc segment of the trough.

The present invention relates the field of microfluidics. In particular, the present invention relates to the microfluidic sorting, separating and/or manipulation of particles. More particularly, the present invention relates to inertial microfluidics, utilizing passive hydrodynamic forces, for sheathless inertial particle focusing and cell sorting.

Sorting of microscopic biological particles (e.g. cells and pathogens) plays an important role in biological analyses and medical diagnostics. For example, the separation of circulating tumor cells (CTCs) from human blood cells and sorting different stem cell types, such as mesenchymal stem cells (MSCs) and hemopoietic stem cells (HSCs), is of great interest for clinical analyses and biological research. High throughput is one of the primary constraints to make current cell sorting technologies viable for practical biomedical applications.

Practical biomedical analyses typically require the processing of 1-10 mL raw biological sample from patients. Sample purification is generally needed before actual biomedical analysis to improve sensitivity and selectivity. Therefore, it is highly desired to purify samples at a very high throughout manner (˜mL/min) to minimize the overall turnaround time. The current cell sorting technologies either require intensive labor (centrifugation) or expensive instrument (fluorescence-activated cell sorting).

Precise manipulation and separation of cells in microscale is an essential enabling technology for biological studies, and also presents immensely commercial potential in the bioengineering and pharmaceutical industry. In the past two decades, various microfluidic cell sorting technologies have been developed and can be classified as active and passive methods. Conventional active methods generally apply external acoustic^{1,2,3,4,5}, electric^{6,7,8,9,10} and magnetic^{11,12,13} fields, embracing the preponderant ability of highly accurate cell separation. However, the extensive utilization of active cell separation methods in practical application is hampered owing to complicated device fabrication and integration, relatively low throughput especially when it requires processing a large amount of sample volume, on the order of a few ml, to isolate extremely low-abundance biological particles. Passive cell sorting techniques mainly include size-based microfiltration^{14,15}, deterministic lateral-displacement (DLD)^{16,17,18} and inertial focusing. As far back as 1961, Segré and Silberberg¹⁹ firstly observed that particles would spontaneously form an annulus pattern along a cylindrical pipe in a laminar flow regime (tubular pinch effect), which arises from the balance between two opposing inertial lift forces. This lateral migration to deterministic equilibrium positions is known as the inertial focusing phenomenon. This passive particle focusing phenomenon is a result of the inertial lift force when the fluid flows are in an intermediate Reynolds number regime (˜1<Re<˜100). In recent years, it has been found that the inertial focusing of micron-sized particles (typically larger than 1 micron) can also be achieved in microfluidic devices when they are operated at very high flow rates (˜mL/min). The requirement of high flow rate for effective inertial focusing also enables high throughput sample processing that is needed in practical biomedical applications. Inertial focusing has sprung up as one of the powerful precise cell manipulation techniques in microfluidics since 2007²⁰, and has then gradually obtained great attention in the microfluidics research community by virtue of its high throughput, low energy consumption, simple device structure and friendly fabrication procedure, as well as ease of working as functional components combined with existing microfluidic chip^{21,22,23}.

Inertial focusing is a passive microfluidic manipulation technology, in which the size-selective manipulation highly depends on the channel geometry. Various channel geometry designs have been adopted to demonstrate inertial focusing, including straight^{24,25,26,27,} curved/serpentine^{28,29,30,31} asymmetric curves^{32,29,33}, spiral^{34,35,27,36} and contraction/expansion^{37,38,39,40}, among which each channel design exhibits different inertial focusing behavior²¹. Microfluidic channels with curvilinear or expansion-constriction features can produce a Dean secondary flow perpendicular to the main flow direction. The generation of the Dean flow results from the inertia mismatch of continuous flow in the center and near-wall regions, which is typically counter-rotating Dean vortices along the cross-section of the channel. The Dean secondary flow accordingly produces a Dean drag force that can be used to balance the inertial lift force and thus provides flexibility to control particle's equilibrium positions.⁴¹ In particular, the Dean drag force and inertial lift force scale with the particle size very distinctively, which enables differential equilibrium positions of differently sized particles for particle sorting in continuous flows.⁴² The secondary Dean flow also helps reduce the number of equilibrium positions that is needed for the convenience of sample collection.

As a pluripotent microfluidic manipulation method, inertial focusing has been applied in multiple applications, such as sheathless alignment in flow cytometry^{43,30}, size-dependent cell separation^{36,44,45}, deformability dependent cell separation⁴⁶, rare cell separation^{34,32,40,47,} bacteria isolation²⁶, platelet separation²⁹, plasma extraction⁴⁸ and solution exchange^{40,49}, just to name a few. Notably, circulating tumor cells (CTCs) are malignant cancer cells shed from primary tumor (or tumor after metastasis), undergoing epithelial-mesenchymal transition (EMT) and then intruding into circulatory system. CTCs are considered as prerequisite of tumor metastasis, and the ability to capture and analyze CTCs enables early diagnosis of cancer and systematic study of cancer metastasis. However, CTCs are extremely rare in the bloodstream (i.e. tens of CTCs in 1 ml whole blood sample⁵⁰), therefore CTC sorting technologies need to fulfill the requirements in high throughput, purity and capture rate for practical research and clinical demands. Since inertial focusing has the ability to process samples at a high-throughout manner, there has been an increasing interest in developing high-throughput inertial sorting or enrichment technology. For example, spiral channel is a design that has been extensively studied and applied for inertial cell focusing and sorting, for example rare cell isolation^{51,52,35} (e.g. CTCs), specific cell type separation^{36,44,27} and encapsulation of single cells⁵³. Majid Ebrahimi Warkiani et al. achieved at least 85% recovery rate of cancer cells spiked in lysed blood sample using spiral inertial device combined with sheath flow⁵⁴, and more than 80% recovery of cancer cells spiked in whole blood through slanted spiral channel with sheath flow⁵¹. Jiashu Sun et al. obtained 88.5% recovery rate of cancer cells spiked into whole blood with double spiral microchannel³⁵.

Such spiral inertial device cannot effectively focus smaller bacteria because of the weak Dean secondary flow. As such, they may be used for blood cell enrichment and cannot be used to separate remove bacteria from a blood sample. Our design using viscoelastic fluids with the addition of biocompatible polymer could achieve elasto-inertial focusing and sorting of submicron particles from clinical samples.

In the present invention, a novel channel design with a series of reverse wavy channel structures for sheathless inertial particle focusing and cell sorting was devised. By “reverse”, it is meant to refer to a reverse of the Dean secondary flow in the curved unit according to an embodiment of the present invention. In various embodiments, a single wavy channel unit consists of four semicircular segments, which produce periodically reversed Dean secondary flow along the cross-section of the channel. The balance between the inertial lift force and the Dean drag force results in deterministic equilibrium focusing positions, also depending on the size of the flow-through particles and cells. Six fluorescent microspheres (15 μm, 10 μm, 7 μm, 5 μm, 3 μm and 1 μm) were used to study the size-dependent inertial focusing behavior. Our novel design with sharp turning subunits could effectively focus particles as small as 3 μm, the average size of platelets, enabling the sorting of cancer cells from whole blood without the use of sheath flows. With an optimized channel design, size-based sorting of MCF-7 breast cancer cells spiked in diluted whole blood samples without using sheath flows was demonstrated. A single sorting process was able to recover 89.72% MCF-7 cells from the original mixture and enrich MCF-7 cells from the original purity of 5.3% to 68.9% with excellent cell viability.

Moreover, four differently sized fluorescent submicron spheres (1 μm, 500 nm, 300 nm and 100 nm) were used to study the focusing behavior within viscoelastic fluids under various conditions. A simple, high-throughput and label-free sorting of submicron exosomes with purity higher than 88% and recovery higher than 76% was achieved.

The listing or discussion of an apparently prior-published document in this specification should not necessarily be taken as an acknowledgement that the document is part of the state of the art or is common general knowledge.

Any document referred to herein is hereby incorporated by reference in its entirety.

The present invention presents a family of new inertial microfluidic devices for high throughput cell sorting at flow rates on the order of ˜mL/min. In particular, the present invention takes advantages of the balance between inertial lift force and drag force from secondary Dean flow. The differential equilibrium positions of flow-through cells that are highly dependent on their sizes thus enable high throughput size-based cell sorting. The secondary Dean flow is produced by periodic turning channel structures. For submicron particle focusing, by introducing the viscoelastic fluids with the addition of biocompatible polymer, the wavy channel can produce a larger elastic force to promote a better particle focusing toward the channel centerline region both in vertical and horizontal directions compared with the traditional straight channel. Different geometry designs of these turning structures results in varying equilibrium positions, which implies that specific cell sorting applications require unique designs of these periodic turning channel structures. This family of new inertial microfluidic devices has great potential to be applied for high throughput and high fidelity sorting of rare cell populations in complex biological samples with a volume of 1-10 mL, for example circulating tumor cells, exosomes and pathogens in whole blood samples.

In an aspect of the present invention, there is provided a device for sorting, separating or manipulating particles in a fluid suspension, the device comprising: (a) at least one inlet for introducing the fluid suspension; (b) at least one outlet for discharging the fluid suspension containing particles of a desired size; and (c) a channel in fluid communication with and intermediate the at least one inlet and the at least one outlet, a portion of the main channel is curved to form at least one curved unit, the curved unit is shaped to form a profile of a wave having a crest, a lip that curls over a trough, and a face, wherein the crest, lip, face and trough of the curved unit each forms a semicircular arc segment, the fluid suspension travels through the curved unit from the semicircular arc segment of the crest to the semicircular arc segment of the trough.

Advantageously, the device of the present invention having at least one curved unit having sharp-turnings could effectively focus particles as small as 3 μm and easily achieve tunable particle separation with changing the radius parameters. Also, by introducing viscoelastic force, submicron particle focusing can be achieved. By “curved”, it is meant to include any bending of the main channel. For example, the channel may be bent to create a zig-zag configuration, a semicircle configuration, an O-shape configuration, a spring/spiral-shape configuration, or the like.

It various embodiments, the curved unit of the present invention resembles that unbroken wave such that the curvature of the curved unit can be designed to have much smaller radius of curvature compared to spiral channels of exiting art. Such spiral channels have a gradually increasing radius of curvature. Therefore, these periodic turning channel structures created by the curved unit can produce a much stronger secondary Dean flow than the spiral channel, thus enabling the focusing of ˜1 μm particles (focusing of 1 μm particles is challenging for spiral channels). The ability to effectively manipulate ˜1 μm particles is critical important for bacteria sorting since a majority of them are smaller than 4 μm. A straight channel cannot achieve the bacteria focusing with pure inertial forces (i.e. without introducing Dean drag force) with such small particle size. The present curved unit can effectively focus particles as small as 3 μm and easily achieve tunable particle separation by changing the radius parameters according to the teachings of the present invention.

In various embodiments, the diameter of the semicircular arc segment of the trough is equal to or greater than the diameter of the semicircular arc segment of the crest.

In various embodiments, the main channel comprises a plurality of curved units.

In various embodiments, the plurality of curved units are arranged in a linear direction. Although a single channel can process samples at a rate of 0.1-1 ml/min, channel parallelization is still needed for high throughput cell sorting in practical applications. Channel parallelization, i.e. having multiple channels running in parallel, is difficult to achieve in spiral microfluidic devices. In the present invention, such plurality of curved units may be arrayed or arranged in a linear direction, which is easier to implement channel parallelization compared to spiral channels.

In various embodiments, the plurality of curved units comprises between 10 to 40 curved units.

In various embodiments, the device comprises more than one outlet. For example, the device may comprise three outlets, i.e. a first outlet, second outlet and third outlet, wherein each outlet discharges a different sized or type of particle in the fluid suspension sample.

In various embodiments, the widths of the first, second and third outlets are different. The widths of the first, second and third outlets may be 30-80 μm, 40-55 μm and 30-80 μm respectively. The widths may be adjusted according to the targets/particles that are being manipulated.

In various embodiments, the main channel has a rectangular cross-section profile. In an example, the main channel has a width of 20-125 μm and a height of 5-40 μm.

In various embodiments, each of the inlet and the at least one outlet further comprises a reservoir for the fluid suspension and sorted particles in a suspension respectively. In an example, the diameter of the reservoir is 1.5 mm.

In various embodiments, the diameter of the semicircular arc segment of the crest is between 600 to 800 μm, the diameter of the semicircular arc segment of the face is between 200 to 350 μm, the diameter of the semicircular arc segment of the lip is between 200 to 350 μm, and the diameter of the semicircular arc segment of the trough is between 600 μm to 1200 μm.

It should be noted that inertial sorting is a passive technique and the focusing, sorting or manipulation efficacy highly depends on the channel geometry, specific dimensions and operational flow conditions. For different cell sorting applications, the channel geometry and dimensions will need very careful design that is definitely patentable. As such, as will be described in detail below, the selection of the geometry and design configuration of the curved unit of the present invention is not an arbitrary one.

In another aspect of the invention, there is provided a method for sorting, separating or manipulating particles in a fluid suspension, the method comprising: (a) providing at least one inlet for introducing the fluid suspension; (b) providing at least one outlet for discharging the fluid suspension containing particles of a desired size; (c) a main channel in fluid communication with and intermediate the at least one inlet and the at least one outlet, a portion of the main channel is curved to form at least one curved unit, the curved unit is shaped to form a profile of a wave having a crest, a lip that curls over a trough, and a face, wherein the crest, lip, face and trough of the curved unit each forms a semicircular arc segment; and (d) pumping the fluid suspension through the curved unit from the semicircular arc segment of the crest to the semicircular arc segment of the trough.

In various embodiments, the method further comprises pumping the fluid suspension through the curved unit wherein the diameter of the semicircular arc segment of the trough is equal to or greater than the diameter of the semicircular arc segment of the crest.

In various embodiments, the method further comprises pumping the fluid suspension through a plurality of curved units that are arranged in a linear direction, the plurality of curved units comprises between 10 to 40 curved units.

In various embodiments, the method further comprises pumping the fluid suspension at a flow rate of between 40 μl/min to 200 μl/min.

In various embodiments, the method comprising pumping the fluid suspension through a wave-shaped curved unit wherein the diameter of the semicircular arc segment of the crest is between 600 to 800 μm, the diameter of the semicircular arc segment of the face is between 200 to 350 μm, the diameter of the semicircular arc segment of the lip is between 200 to 350 μm, and the diameter of the semicircular arc segment of the trough is between 600 μm to 1200 μm.

In various embodiments, the method further comprises discharging the fluid suspension in three outlets, a first, second and third outlet.

In various embodiments, the method further comprises discharging the fluid suspension containing particles having a size of about 3 μm to 10 μm at the first outlet, discharging the fluid suspension containing particles having a size of about 15 μm at the second outlet, and discharging the fluid suspension containing particles having a size of about 3 μm at the third outlet.

In various embodiments, the fluid suspension is a whole blood sample and the method separates cancer cells from the sample, separate different types of blood cells or separate submicron vesicles and exosomes from the fluid suspension sample.

In various embodiments, the method separates particles having a size (larger or equal) of about 300 nm from particles having a size of about 100 nm.

Advantageously, the present invention has high potential to be applied for high throughput and high fidelity sorting of rare cell populations in biological research and clinical diagnosis.

In order that the present invention may be fully understood and readily put into practical effect, there shall now be described by way of non-limitative examples only preferred embodiments of the present invention, the description being with reference to the accompanying illustrative figures.

In the Figures:

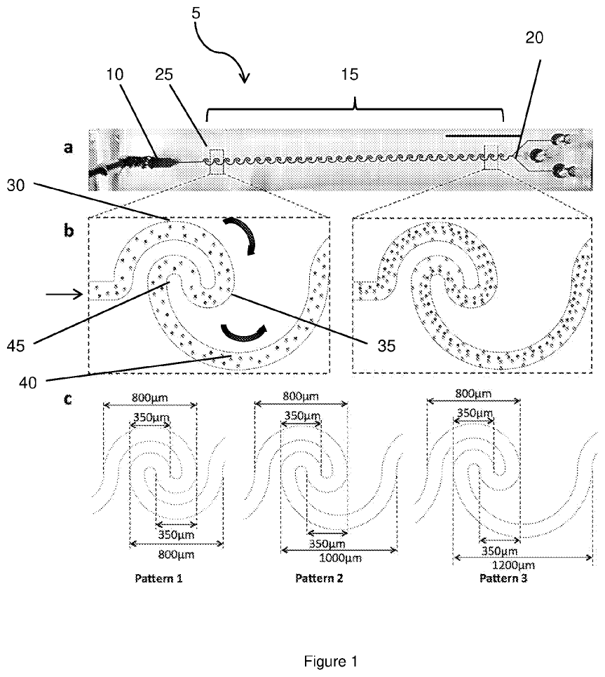

FIG. 1. Three different channel designs for inertial focusing with a series of reverse wavy channel units. (a) Photograph of a representative inertial sorting microfluidic device. The injection of the blue dye into the microchannel helps visualize the channel design. Scale bar is 1 cm. (b) Schematic inertial focusing behavior of three differently sized microparticles (3 μm: blue, 10 μm: red and 15 μm: green) in a single mixed input. (c) Detailed geometric parameters of each pattern. Pattern 1-3 share the same geometric parameters of the upper semicircle (both outer and inner semicircle) and lower inner semicircle, with the lower outer semicircle having 200 μm increment. All the channel designs have a width of 125 μm and a height of 40 μm.

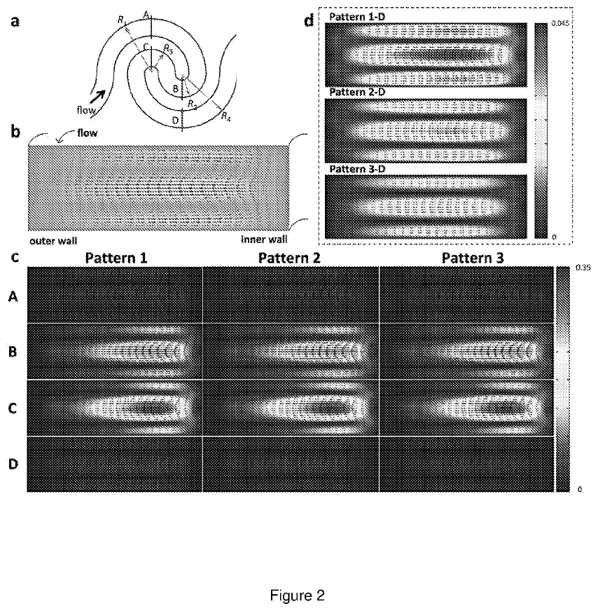

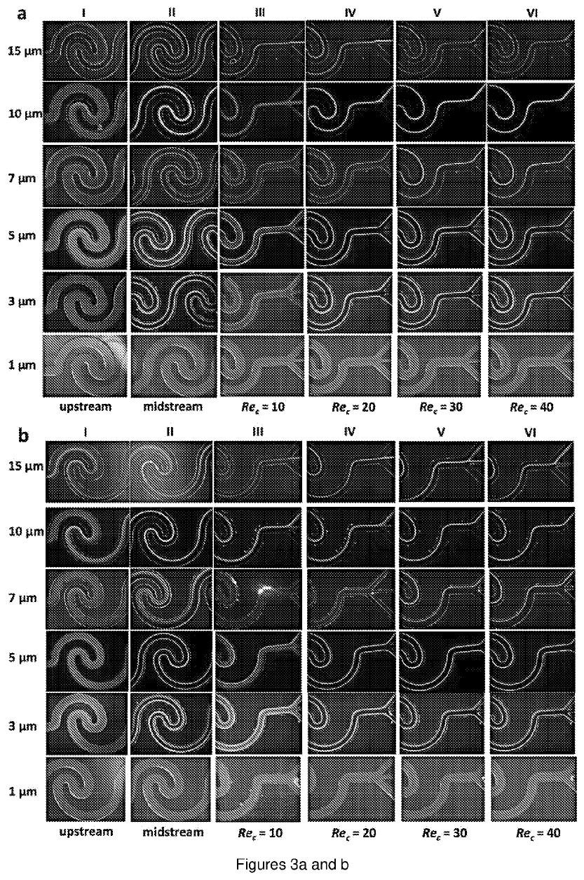

FIG. 2. Numerical simulation of the Dean secondary flow at different cross-sections in the three channel designs. (a) Four cross-sections A-D selected to visualize the Dean flow along a single wavy channel unit. R₁, R₂, R₃ and R₄ are the radius of curvature of the upper outer semicircle, lower inner semicircle, upper inner semicircle, and lower outer semicircle, respectively. (b) A typical Dean secondary flow (two symmetric counter-rotating vortices) along the channel cross-section. (c) Simulated velocity profile along the four cross-sections A-D in the three channel designs. All the left sides refer to the outer wall of the channel. The color level represents the magnitude of the Dean flow velocity. (d) Zoomed-in scale of the velocity profile at cross-section D in the three channel patterns.

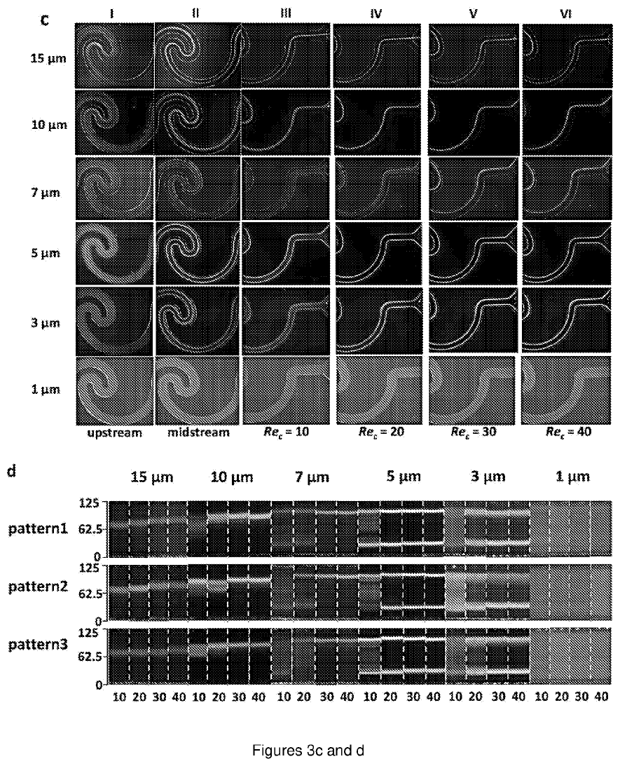

FIG. 3. Fluorescence microscopic images of six differently sized particles (15 μm, 10 μm, 7 μm, 5 μm, 3 μm and 1 μm) undergoing inertial focusing in the three channel designs (a: Pattern 1; b: Pattern 2; c: Pattern 3). Column I and II shows the particle trajectory in the upstream and midstream, respectively. Column III-VI shows the particle trajectory in the downstream at Re_{c}=10 (flow rate: 49.41 μl/min), 20 (flow rate: 98.83 μl/min), 30 (flow rate: 148.25 μl/min) and 40 (flow rate: 197.60 μl/min), respectively. (d) Comparison on the focusing position of the six particles in the downstream among the three channel designs. Abscissa and ordinate represent the channel Reynolds number Re_{c} and the channel width, respectively.

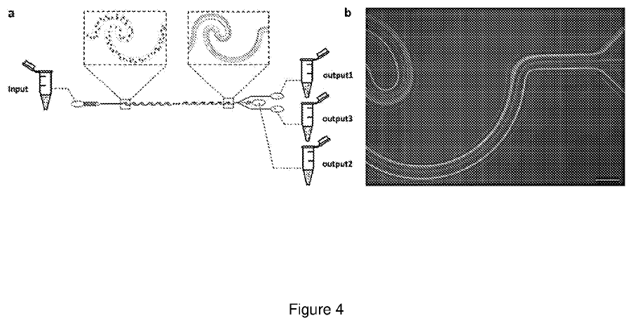

FIG. 4. Separation of three differently sized particles using Pattern 3 sorting device. (a) Schematic experimental setup of the separation of three differently sized microparticles (3 μm, 10 μm and 15 μm) in a single mixed input. (b) Fluorescent streaks of the three particles at the trifurcated outlets. The 10 μm (red fluorescence) and 15 μm particles (green fluorescence) were collected in output 1 and 2, respectively. The 3 μm particles (blue fluorescence) were collected in both output 1 and 3. The flow rate was 197.60 μl/min (Re_{c}=40). Scale bar is 125 μm.

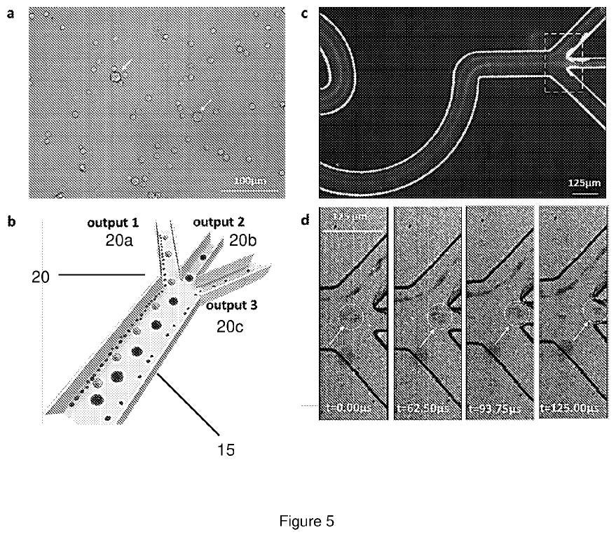

FIG. 5. Separation of cancer cells from whole blood in the Pattern 3 sorting device. (a) Microscopic image of individual cells in the mixture. The two yellow arrows indicate two individual MCF-7 cells that are much larger compared to surrounding blood cells. Scale bar is 100 μm. (b) Schematic diagram shows the separation of cancer cells from diluted (100×) whole blood, in which the expected focusing positions of cancer cells, WBCs and RBCs are presented. (c) Fluorescence image of the focused cancer cells at the trifurcated outlets. Cancer cells are focused along the green line (exited from output 2), and RBCs are focused along the dim red line (exited from output 1). Scale bar is 125 μm. (d) The separation process of an individual MCF-7 cell from other blood cells captured by a high-speed camera in the bright field mode (The field of view is the dashed box shown in c). The arrows indicate the position of MCF-7 at the corresponding time instants. Scale bar is 125 μm.

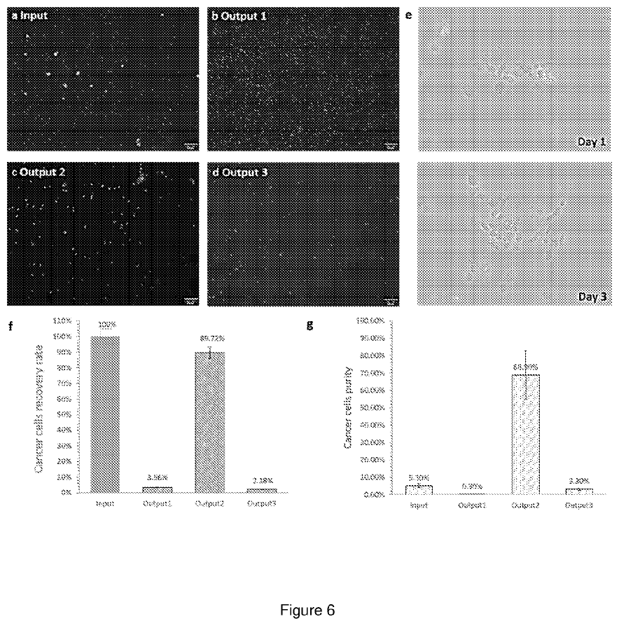

FIG. 6. Microscopic images and flow cytometric results of pre-mixture and sorted samples. (a-d) Fluorescence image of diluted whole blood mixed with cancer cells from input to output through inertial sorting device (Pattern 3). MCF-7 is indicated by the green fluorescence. Scale bar is 100 μm. (e) MCF-7 cells collected from output 2 were cultured and were able to proliferate. (f) Recovery rate of MCF-7 cells through the inertial sorting device at the three outputs, which was obtained by the flow cytometric analyses. (g) Purity of MCF-7 cells through the inertial sorting device at the three outputs and inlet.

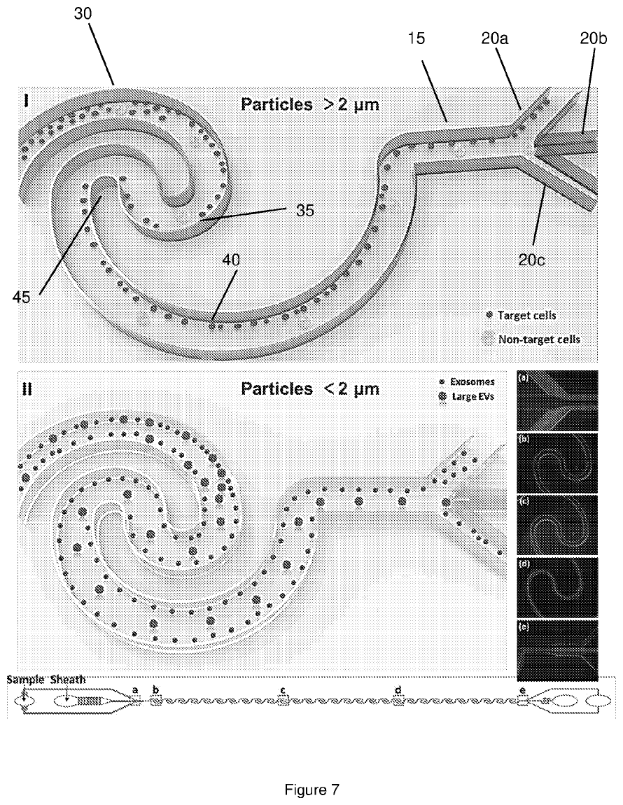

FIG. 7. Schematic of the inertial sorting technology with wavy microchannel structures for single target cell in a heterogenous cell sample: (I) isolation of micron-sized circulating tumour cells (CTCs); (II) isolation of submicron exosomes.

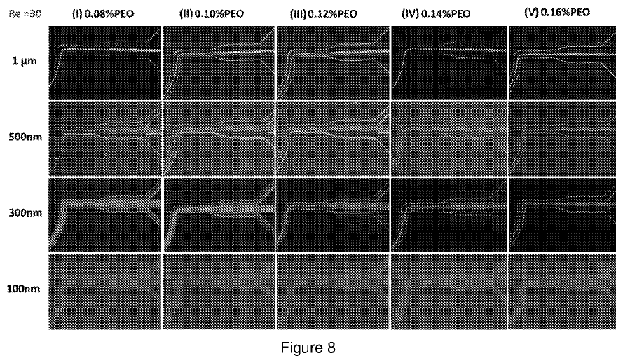

FIG. 8. Fluorescence microscopic images show the elasto-inertial focusing of four differently sized submicron spheres (1 μm, 500 nm, 300 nm and 100 nm) along the wavy channel with varying PEO concentrations in the viscoelastic fluids. Images show one unit near the downstream trifurcated output section of microchannel. All experiments were performed at the same conditions at Reynolds number Re_{c}=30 (flow rate: 44.90 μl/min). Column (I) to (V) represents the relative PEO concentration from 0.08 wt % to 0.16 wt %.

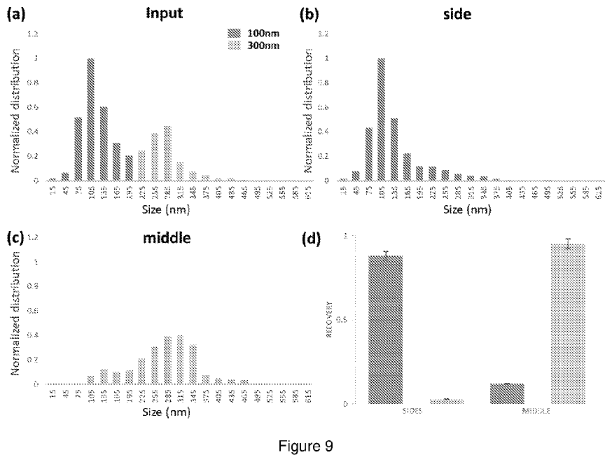

FIG. 9. NTA results of separation on two differently sized 100 nm (blue) and 300 nm (pink) particles using the wavy channel with viscoelastic fluids. (a) Normalized distribution of the mixture sample of 100 nm and 300 nm particles before sorting. (b) Normalized distribution of the sample collected from side output. (c) Normalized distribution of the sample collected from middle output. (d) Recovery rates calculated from NTA results for samples collected from both middle and side outputs.

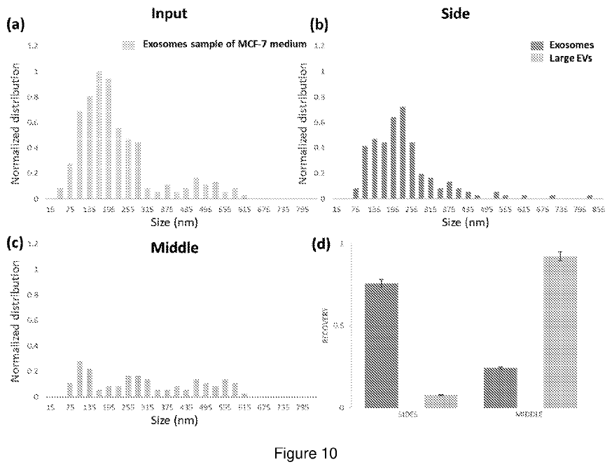

FIG. 10. NTA results of separation on exosomes and larger EVs in MCF-7 culture medium using the wavy channel with viscoelastic fluids. (a) Normalized distribution of mixture of exosomes and large EVs before sorting. (b) Normalized distribution of the sample collected from side output. (c) Normalized distribution of the sample collected from middle output. Concentration is 5×10⁸ particles/ml for (a)-(c). (d) Recovery rates of exosomes and larger EVs calculated from NTA results for samples collected from both middle and side outputs.

In the present invention, a novel geometric channel design, asymmetric reverse wavy microchannel, for sheathless inertial particle focusing and cell sorting is devised. Although multiple cross-section shapes such as trapezoid⁴⁴, circle, semi-circle and triangle⁵⁵ have been studied, classic rectangular cross-section design was chosen because of its simple fabrication process. Inertial focusing behaviors of six fluorescent micron-sized particles (15 μm, 10 μm, 7 μm, 5 μm, 3 μm and 1 μm) in three channel pattern designs have been experimentally examined. It has been found that the minimum particle size for effective inertial focusing is between 1-3 μm. On the basis of these experimental studies, an optimized channel design to fulfill the requirement in separating cancer cells for whole blood sample was identified. In order to demonstrate the application potential of this novel device design, diluted whole blood samples spiked with breast cancer cells, mimicking the clinical CTC samples, were used to test the sorting performance of our inertial microfluidic device. One single sorting process is able to recover 89% cancer cells and increase the purity of cancer cells by 13 times. Compared with previous inertial sorting devices, the present novel design with extremely sharp turning sub-units can effectively focus cells as small as 3 μm, and can thus effectively separate the three major blood cell types (i.e. red blood cells, white blood cells, and platelets) from cancer cells without the use of sheath flows. In addition, the repeated wavy units are arrayed in a linear direction, which enables easier horizontal (2D) and vertical (3D) parallelization of multiple channels for handling large volume samples. Moreover, four differently sized fluorescent submicron spheres (1 μm, 500 nm, 300 nm and 100 nm) were used to study the focusing behavior within viscoelastic fluids under various conditions. A simple, high-throughput and label-free sorting of exosomes with purity higher than 88% and recovery higher than 76% was achieved. This developed elasto-inertial exosome sorting technique may provide a promising platform in various exosome-related biological research, clinical and pharmaceutical applications.

FIG. 1 shows an embodiment of the inertial device 5 for sorting, separating or manipulating particles in a fluid suspension. With reference to FIG. 1, the device 5 comprises an inlet 10 for receiving or introducing a fluid suspension, a channel 15, and an outlet 20. As such, the fluid suspension travels from the inlet 10 through the channel 15 and out of the device 5 via the outlet 20.

By “fluid suspension”, it is meant to include any fluid comprising a suspension of particles that are desired to be sorted, separated or manipulated. The particles may be biological matter or otherwise. In various embodiments, as will be described in detail below, the fluid suspension may be a blood sample comprising blood components.

The figure shows the inlet 10 and outlet 20 disposed at opposing ends with the channel 15 in fluid communication with and intermediate the inlet 10 and outlet 20. The outlet 20 is adapted for discharging the sorted/separated/manipulated particles. In various embodiments, the outlet 20 may comprise more than one. For example, FIG. 5b shows three outlets 20a, b and c. Each outlet is adapted for sorting particles of a particular size. The way the device 5 achieves the sorting is to have a portion of the channel 15 curved to form at least one curved unit 25. FIG. 1b shows an exploded view of the curved unit 25 according to an embodiment of the present invention.

The curved unit 25 is shaped to form a profile of a wave having a crest 30, a lip 35 that curls over a trough 40, and a face 45, wherein the crest 30, lip 35, face 45 and trough 40 of the curved unit 25 each forms a semicircular arc segment. The arrows shown in FIG. 1b and 2a show the direction of travel of the fluid suspension through the curved unit 25, i.e. from the semicircular arc segment of the crest 30 to the semicircular arc segment of the trough 40.

By “semicircular arc segment”, it is meant to include any curved line. In various embodiments, it is also meant to include any curved line that may form part of a circle. Such segments include any region of a circle that is “cut off” from the rest of the circle by a secant or a chord. In the context of the present invention, any curved line would mean a curved channel 15 that is disposed between the inlet 10 and outlet(s) 20. In non-limiting specific embodiments of the present invention, the semicircular arc segments may be a half circle, formed by cutting a whole circle along a diameter line.

The curved unit 25 may be described in greater detail. As can be seen in the figures, the wave profile of curved unit 25 may have upper semicircles represented by the crest 30 (the upper outer semicircle) and face 45 (the upper inner semicircle) of the wave profile respectively, and lower semicircles represented by the lip 35 (the lower inner semicircle) and trough 40 (the lower outer semicircle) of the wave profile respectively). The upper and lower semicircles oppose each other about an imaginary horizontal axis.

### Concept and Operating Principle

When a solid particle is flowing along a bounded straight channel in an intermediate Reynolds number regime (˜100>Re>˜1), in addition to the viscous drag force exerted on the particle along the main flowstream direction, there are four types of inertial lift forces acting on the particle perpendicular to the main flow²²: i) Magnus force owing to particle slip-rotation; ii) Saffman force owing to particle slip-shear; iii) shear gradient induced lift force owing to curvature of fluid velocity profile (pointing from particle to wall), and iv) wall induced lift force owing to interaction between particle and wall (pushing particle away from wall). Among these forces, the Magnus force and Saffman force are typically much smaller compared to the other two lift forces and can usually be ignored in microfluidic sorting applications. The balance of the two latter inertial lift forces results in the tubular pinch effect along a cylindrical pipe observed by Segre and Silberberg.¹⁹ According to Asmolov's model^{56,42}, the net inertial lift force consisting of the two major lift forces can be expressed as follows,

$$\begin{matrix}near center \text{:} {F}_{L} = \frac{{f}_{L} {ρ}_{f} {U}^{2} {a}^{4}}{{H}^{2}} & ( 1 ) \\ near wall \text{:} {F}_{L} = \frac{{f}_{L} {ρ}_{f} {U}^{2} {a}^{6}}{{H}^{4}} & ( 2 )\end{matrix}$$

In the above, f_{L} refers to the lift coefficient which usually takes as 0.5²⁰ when the Reynolds number Re<100, ρ_{f}, U and a refers to the fluid density, fluid velocity and particle diameter, respectively. H here is defined as the hydraulic diameter and calculated in a rectangular channel as 2wh/(w+h), in which w refers to the channel width and h refers to the channel height of the cross-section.

Steady-state incompressible Navier-Stokes equation (eqn. 3) and continuity equation (eqn. 4) are used to describe the fluid flows inside the microchannel. The term on the left hand side of eqn. 3 is the inertia of the fluids that produces the Dean secondary flow in the sharp turnings.

ρ_{f}(\vec{u}·∇)\vec{u}=−∇p+μ∇²\vec{u} (3)

∇·\vec{u}=0 (4)

In order to quantify the relationship between inertial force and viscous force acting on the fluid, the channel Reynolds number, Re_{c} is defined as follows,

$$R {e}_{c} = \frac{{U}_{m} {ρ}_{f} H}{μ} \qquad ( 5 )$$

where Uₘ is the maximum flow velocity and μ is the flow viscosity. \vec{u} is the fluid velocity vector and p is the fluid pressure.

The introduction of secondary lateral flows, for example curvature-induced Dean flow in an intermediate Reynolds number regime, enables more controllability on the particle's equilibrium positions²¹. Due to the mismatch of lateral centrifugal force on the continuous flow in the center and near-wall regions and conservation of mass, two counter-rotating Dean vortices could be generated along the cross-section of the curved channel. A dimensionless Dean number, De, is used to characterize the Dean flow strength^{41,57},

$$D e = R {e}_{c} \sqrt{\frac{H}{2 R}} \qquad ( 6 )$$

where R refers to the radius of curvature. The magnitude of the Dean flow scales with Uₘ² as

$${U}_{D} ∼ D {e}^{2} \frac{μ}{{ρ}_{f} H} \qquad ( 7 )$$

The Dean flow drags the particle that is perpendicular to the main flow direction, and the Dean drag force can be defined as

$${F}_{D} = 3 π μ {aU}_{D} \sim \frac{{ρ}_{f} {U}_{m}^{2} {aH}^{2}}{R} \qquad ( 8 )$$

The Dean drag force has a linear size scaling, which is different from the size scaling of the net inertial lift force. Therefore, the concurrent effect of Dean drag force and net inertial lift force results in differential equilibrium positions of differently sized particles, which enables size-based inertial sorting in a continuous flow.

Two empirical parameters have been found in previous studies of certain channel geometries to guide the design of inertial sorting devices. First, a/H>0.07 is generally recommended in order to achieve successful inertial focusing.²⁰. Another empirical parameter R_{f} was the ratio of inertial lift to Dean drag force, defined as below²³:

$${R}_{f} = \frac{2 {a}^{2} R}{{H}^{3}} \qquad ( 9 )$$

When R_{f}>˜0.08, it implies that the inertial lift force dominates over the Dean drag force. On the contrary, the particle motion is dominated by the Dean flow rather than the inertial lift force when R_{f}<˜0.08. And a too small value of R_{f} would generate chaotic particle motion instead of deterministic particle focusing.

For non-Newtonian viscoelastic fluids, an additional elastic force generated on particles also comes into play to affect the particle's equilibrium focusing positions. Weissenberg number, Wi, is utilized to measure the viscoelastic effect on fluid,^{58,59,60}

$$Wi = λ \dot{ϒ} = λ \frac{2 U}{H} \qquad ( 10 )$$

λ here refers to the fluid relaxation time and \dot{Υ} represents the fluid shear rate over the channel cross-section. Particles flowing in the viscoelastic fluid are subject to the first and second normal stresses^{61,62}, N₁=τ₁₁−τ₂₂ presents the tension along the main flow direction⁶³ and N₂=τ₂₂−τ₃₃ exerts secondary flow along the cross-section of channel⁶⁴, where τ₁₁, τ₂₂ and τ₃₃ represents flow, velocity gradient and rotational direction, respectively. As N₂ is negligible because the magnitude of N₁ is much larger than N₂ in most viscoelastic solutions^{65,66}, the elastic force exerted on the particle pointing to the smaller shear rate region can be expressed as^{67,68,69},

F_{E}=C_{E}d³∇N₁˜d³(∇τ₁₁−∇τ₂₂) (11)

where C_{E} refers to the non-dimensional elastic lift coefficient.

FIG. 1 shows three different channel patterns to understand how the radius of the lower outer semicircular affects the inertial particle focusing in these channel geometries. Patterns 1-3 possess an identical upper semicircular design and a different lower outer semicircular setting, in which pattern 1 is geometrically symmetric with respect to the center of the unit pattern while pattern 2 and 3 exhibit certain degrees of geometric asymmetry. All the three channel designs are using one single inlet design, and the main channel has a width of 125 μm and a height of 40 μm, a low aspect ratio design (AR=h/w=0.32). The width of the three outlet branches is 80 μm, 45 μm and 80 μm, respectively. Diameter of the inlet and outlet reservoirs is 1.5 mm. FIG. 1a shows a representative microfluidic channel with serial reverse wavy channel structures, in which the randomly distributed particles at the inlet could be deterministically focused into differential tight streaks when exiting the channel based on the particle size (FIG. 1b). Detailed geometric parameters of these pattern designs are shown in FIG. 1c.

### Materials and Methods

### Device Fabrication

The three different microchannels were fabricated using a standard polydimethylsiloxane (PDMS) soft-lithography process, in which the master molds for PDMS casting were fabricated with SU-8 (SU-8 2025, MicroChem, Newton, Mass., USA) on a silicon wafer. The PDMS microchannel layer and an ultrasonic cleaned glass slide were treated with air plasma (Harrick Plasma PDC-32G, Ithaca, N.Y., USA) to generate hydroxyl functional group on the surfaces. The treated surfaces were then brought into contact to form a closed microchannel.

### Numerical Modelling

A finite element method (FEM) based numerical simulation was conducted using COMSOL Multiphysics 5.0 laminar flow module in steady state study (www.comsol.com). The model consists of three reverse wavy channel units with the geometry dimensions and inlet flow rate the same as the experiments. Incompressible Navier-Stokes equation (eqn. 3) and continuity equation (eqn. 4) were the governing equations to simulate the fluid motion inside the microchannel, which could help understand how the Dean secondary flow affects the inertial particle focusing. The boundaries other than the inlet and the outlet were set as non-slip condition. Inlet velocity at a flow rate of 197.60 μl/min (corresponding to channel Reynolds number Re_{c}=40) was calculated and the maximum Dean flow velocity was also obtained.

### Cell Culture

MCF-7 breast cancer cell line was purchased from the American Type Culture Collection (ATCC Cat. No. HB-72), and was cultured in Dulbecco's Modification of Eagle's Medium (DMEM) (Thermo Fisher Scientific, USA) supplemented with 10% fetal bovine serum (FBS, Thermo Fisher Scientific, USA) to provide growth factors and antibiotics including penicillin and streptomycin (Thermo Fisher Scientific, USA) to prevent the growth of bacteria. The cells were sub-cultured every 2 to 3 days when the monolayer reached 80-90% confluence and maintained at 37° C., 5% (v/v) CO₂ in a humidified incubator. Cells were then trypsinized with 0.25% Trypsin-EDTA solution (Thermo Fisher Scientific, USA).

### Sample Preparation

Fluorescent polystyrene microspheres (15 μm, 10 μm, 7 μm, 5 μm, 3 μm and 1 μm) were purchased without any further modification (Magsphere, USA). All these fluorescent polystyrene particles were diluted with deionized (DI) water containing 0.6% Pluronic F127 (Sigma-Aldrich, USA) to avoid particle agglomeration and adhesion onto the channel wall. The typical particle concentration used in the following experiments was around 6×10⁶ particles/ml. A mixture of 15 μm, 10 μm and 3 μm particle suspended in DI water (with 0.6% F127) was used to demonstrate size-based particle sorting in continuous flows. Cancer cells (MCF-7) were stained with SYTO 9 fluorescent dye (Thermo Fisher Scientific, USA) and mixed with diluted whole blood (final concentration around 5×10⁷ cells/ml). This cell mixture was used to demonstrate size-based sorting of MCF-7 cancer cells from blood cells using this wavy inertial focusing device.

Fluorescent polystyrene microspheres (1 μm, 500 nm, 300 nm and 100 nm) were purchased without any further modification (Magsphere, USA). To avoid particle agglomeration and adhesion onto the microchannel wall, all these fluorescent polystyrene particles were diluted with Dulbecco's phosphate-buffered saline (DPBS, Thermo Fisher Scientific, USA) containing 0.6% Pluronic F127 (Sigma-Aldrich, USA). The typical particle concentration used in the experiments was around 6×10⁷ particles/ml. The PEO (polyethylene oxide) solutions were made by dissolving PEO (M_{w}=600 KDa, Sigma-Aldrich, USA) powder into DPBS (Thermo Fisher Scientific, USA) with concentrations of 0.08 wt %, 0.10 wt %, 0.12 wt %, 0.14 wt % and 0.16 wt %. After adding PEO powder into DPBS, the solutions need to be gently stirred overnight to keep uniform solution property. The addition of PEO into the aqueous solution makes the fluids non-Newtonian. By doing this, an additional force can be used to manipulate the submicron particles in the fluid.

Extracellular vesicles were collected from MCF-7 cell culture medium after cell growth around 48 h-72 h (cell confluence achieved around 85%). The cell culture supernatant containing extracellular vesicles was then went through the differential centrifugation procedure. First, a centrifugation at a speed of 500×g for 5 min was used to remove the bulky apoptotic and dead cell debris. Subsequently, the remaining intact cells and part of the larger EVs were eliminated by 10 min centrifuging at 2000×g and 12000×g. Note that all centrifugation steps were done at 4° C. to prevent denaturing of the protein contents. The medium was finally processed by membrane filtration (pore size: 0.8 μm, Millipore, USA) to get rid of the undesired debris. The typical vesicle concentration used in experiments was around 5×10⁸ particles/ml.

### Experimental Setup

Each individual experiment was conducted with a new microchannel device to avoid cross-contamination and possible clogging by residual particles or bubbles in used devices. For each experiment, the prepared aqueous sample was continuously infused into the microchannel at flow rates from 49.41 μl/min to 197.60 μl/min (corresponding to Re_{c} from 10 to 40) using a syringe pump. The trajectories of these fluorescent microparticles were recorded using a CCD camera on an inverted microscope (Olympus, CKX53, Japan) to capture the inertial focusing behaviors. The motion of single cells in the trifurcated outlet was captured using a high-speed camera (FASTCAM Mini UX100, PHOTRON, Japan) to visualize the cell separation process. The cell contents in the samples before and after inertial sorting were analyzed by a commercial flow cytometer (Accuri C6, Becton Dickinson, CA, USA) to evaluate the sorting performance. For exosomes isolation experiments, the medium contents in the samples before and after sorting were analyzed by a commercial NTA, Nanoparticle Tracking Analysis system (ZetaView, Particle Metrix, Germany) to get the size distributions and then evaluate the sorting performance. All the samples were diluted with DPBS at concentrations around 5×10⁶ for the NTA measurement to get accurate results and all the measurements were conducted at 22° C. All the data were collected through ZetaView (www.particle-metrix.de) and then analyzed with ZetaView Analyze.

### Results and Discussion

### Simulation of Fluid Flow in the Three Channel Designs

The fluid flow in the three different channel designs were first simulated because in was particularly interesting to investigate the velocity profile along four cross-sections A-D, as defined in FIG. 2a. All the simulations were conducted at a flow rate of 197.60 μl/min (Re_{c}=40). FIG. 2b shows a representative flow profile along one of the channel cross-sections, in which the left and right side is the outer wall (larger radius of curvature) and inner wall (smaller radius of curvature) of the channel, respectively. When the fluid flows through a turning channel, the inertia of the fluid becomes nontrivial at an intermediate channel Reynolds number regime (˜100>Re_{c}>˜1). In the middle region of the channel, the faster moving fluid along the main flow direction tends to move toward the outer wall along the cross-section direction. To conserve the fluid mass in the closed channel, the slower moving fluid near the top and bottom walls tends to move toward the inner wall, generating two symmetric counter-rotating vortices perpendicular to the main flow direction that is called the Dean secondary flow.

TABLE 1
Dean flow maximum velocity at
cross-sections A-D in Pattern 1, 2 and 3

| Maximum Velocity (m/s) | A | B | C | D |
|---|---|---|---|---|
| Pattern 1 | 0.04231 | 0.21362 | 0.29468 | 0.04216 |
| Pattern 2 | 0.04286 | 0.2122 | 0.28832 | 0.03219 |
| Pattern 3 | 0.04165 | 0.2029 | 0.27845 | 0.02599 |

The first column in FIG. 2c shows the Dean secondary flow along the four cross-sections in channel pattern 1 that is designed to be geometrically symmetric with respect to the center of one single wavy channel unit. When the fluid flows through cross-section A, it starts to produce a relatively weak Dean secondary flow along the cross-section. The outer wall in FIG. 2c is always on the left side of the channel cross-section. From cross-section A to B, the fluid flows from the upper outer semicircle to the lower inner semicircle, during which the radius of curvature gradually decreases. As the magnitude of Dean flow inversely scales with R, the Dean secondary flow becomes much more pronounced on cross-section B, as compared to cross-section A. It is worth mentioning that from A to B, the outer wall is along the same channel side. From cross-section B to C, the fluid flows from the lower inner semicircle to the upper inner semicircle, undergoing the steepest flow turning. Though the two cross-sections have the same radius of curvature, the Dean secondary flow becomes even stronger at cross-section C as compared to cross-section B. It can be intuitively understood by considering the variations in radius of curvature from A to B and B to C are different, resulting in considerable difference in the flow development at B and C. The maximum Dean flow velocities at the four cross-sections are listed in Table 1 for quantitative comparison, which reveals ˜27% relative difference in the Dean flow strength between B and C. In particular, because of this reverse wavy channel design, the outer wall from A to B reverses to the inner wall from B to C along the same channel side. It implies that the direction of Dean secondary flow along the cross-section reverses from cross-section B to C. From cross-section C to D, the radius of curvature gradually increases, and the inner wall remains along the same channel side. As a result, the Dean secondary flow becomes weaker when flowing from the upper inner semicircle to the lower outer semicircle. In summary, along a single wavy channel unit, the strength of the Dean secondary flow varies from weak to strong, with the strongest Dean vortices in the inner semicircles, and then becomes weak again when leaving the single wavy channel unit. In addition, the direction of the Dean secondary flow reverses one time through a single wavy channel unit. Although channel pattern 1 is geometrically symmetric with respect to the unit center, the strength of the periodically reversed Dean secondary flow shows some certain degree of asymmetry, in particular along the two inner semicircles.

Different from channel pattern 1, pattern 2 and 3 introduce some degree of geometric asymmetry by increasing the radius of curvature of the lower outer semicircle with 100 μm and 200 μm, respectively. Generally, the Dean flows on the four cross-sections A, B, C and D show similar velocity profiles. Table 1 quantitatively compares the maximum Dean flow velocity at different cross-sections in the three channel pattern designs. The relative difference in the maximum velocity of the three designs at cross-sections A, B and C are lower than ˜5%. As discussed previously, the relative difference in the maximum Dean flow velocity between cross-sections B and C is ˜27% in pattern 1. It has been found that this relative difference remains ˜27% in both pattern 2 and 3, indicating a consistent flow asymmetry from B to C. Since the introduced geometric asymmetry mainly varies the radius of curvature of the lower outer semicircle, it has been found that the relative difference in the maximum velocity at cross-section D between pattern 1 and 2, pattern 1 and 3 is ˜23% and ˜38%, respectively. In order to clearly visualize the Dean flow difference at cross-section D, the scale of flow velocity was zoomed in, as shown in FIG. 2d inside a black dashed box. Clearly, the strength of the Dean vortices at cross-section D reduces from pattern 1 to pattern 3. Because the Dean vortices at cross-section D is about seven to ten time weaker compared to that at cross-section C, the change in the radius of curvature of the lower outer semicircle can be considered as a fine-tuning of the Dean secondary flow in a single wavy channel unit.

### Size-Dependent Inertial Focusing in the Three Channel Designs

The inertial focusing behavior of differently sized microspheres (15 μm, 10 μm, 7 μm, 5 μm, 3 μm and 1 μm) in the three different channel designs were investigated. These microspheres are fluorescent, which allowed to clearly visualize the particle trajectories even at very high flow rates. FIG. 3a-3c shows the fluorescent streak images of differently sized particles at varying flow rates in the three channel designs. Four different flow rates 49.41 μl/min, 98.83 μl/min, 148.25 μl/min and 197.60 μl/min were selected to study the inertial focusing behavior, which corresponds to the channel Reynolds number, Re_{c}=10, 20, 30 and 40, respectively.

Taking a close look at the inertial focusing behavior in channel pattern 1 (FIG. 3a), in the upstream of the channel (the first wavy channel unit as shown in column I of FIG. 3a), the six differently sized fluorescent particles exhibited very similar behavior, fully occupying the entire channel cross-section without obvious inertial focusing effect. In the midstream (column II of FIG. 3a) where the inertial focusing has not reached the steady state (Re_{c}=40), 15 μm and 10 μm particles revealed a tendency of focusing along the centerline of the channel. 7 μm, 5 μm and 3 μm particles tended to form two streaks near the two sidewalls of the channel. The smallest 1 μm showed no tendency of inertial focusing. In the downstream (the last wavy channel unit as shown in columns III to VI of FIG. 3a), also the trifurcate outlets for the collection of differently sized particles, these particles have reached their steady state inertial focusing at different Re_{c}. The 15 μm microspheres were focused to form one single streak along the centerline region of the channel even at Re_{c}=10. As the inertial lift force near the central region scales with U² and a⁴, the 15 μm microsphere was easier than other particle sizes to achieve inertial focusing (a/H=0.354>0.07). Another important parameter for evaluating the role of inertial lift force and Dean drag force is R_{f}=0.354. In the following, all the R_{f} values for different particles were calculated using the radius of curvature along the outer wall of the inner semicircles (R=175 μm). R_{f}=0.354>0.08 implies that the inertial lift force dominates over the Dean drag force, as a result, the equilibrium focusing position of 15 μm particles stayed nearly along the centerline, similar to the inertial focusing along a straight channel with AR=h/w=0.32. At Re_{c}=10 and 20, the 15 μm microspheres eventually flowed into the middle outlet as expected. However, at Re_{c}=30 and 40, the focused 15 μm microspheres flowed into the upper outlet, indicating that its equilibrium focusing position was slightly shifted toward the upper outlet. It is speculated that the Dean drag force increased faster than the inertial lift force for 15 μm microspheres as the flow rate increased. Though the Dean drag force was weaker compared to the inertial lift force, it would mildly shift its equilibrium focusing position away from the centerline.

The 10 μm microspheres (a/H=0.165>0.07, R_{f}=0.157>0.08) also focused into a single streak with the inertial lift force dominating the focusing behavior. Additionally, the relatively weaker Dean Drag force also shifted its equilibrium focusing position upward and thus the 10 μm microspheres flowed into the upper outlet. The inertial focusing behavior of the 7 μm microspheres however varied with the flow rates. a/H=0.115>0.07 implies that it could be effectively focused. R_{f}=0.077 is very close to the empirical value 0.08, indicating that the inertial lift force became comparable to the Dean drag force for 7 μm microspheres. At Re_{c}=10 and 20, the 7 μm microspheres were focused into two streaks near the sidewalls, in which the Dean drag force slightly dominated over the inertial lift force. Since the Dean secondary flow periodically reversed along the repeated wavy channel units, the Dean drag force tended to drag particles towards the two sidewalls. The balance between the Dean drag force and the inertial lift force, in particular the wall-induced lift force, produced equilibrium positions near the sidewalls. However, at Re_{c}=30 and 40, the 7 μm microspheres were focused into a single streak shifted away from the centerline, revealing that the inertial lift force slightly dominated over the Dean drag force. It is speculated that 7 μm is or very close to the threshold size at which the inertial lift force and Dean drag force became equally important. As the two forces varied with the flow rates slightly different, the focusing behavior of the 7 μm microspheres could be readily switched between single streak focusing (shifted from the centerline) and two streaks focusing (near the sidewalls). The two important parameters for the 5 μm microspheres are a/H=0.083>0.07 and R_{f}=0.039<0.08. Therefore, the 5 μm microspheres were dominated by the Dean drag force and thus formed two streaks near the two sidewalls. For 3 μm microspheres, though a/H=0.049<0.07 (R_{f}=0.014<0.08), they were still effectively focused into two streaks near the sidewalls. Note that this empirical parameter a/H=0.07 for effective inertial focusing was obtained from a different channel design, and this threshold value may slightly deviate from 0.07 for different channel designs. For 1 μm microspheres, the two important parameters are a/H=0.016<0.07 and R_{f}=0.002<0.08, therefore they could not achieve apparently clear inertial focusing.

FIGS. 3b and 3c show the inertial focusing behaviors of the six differently sized particles in channel Pattern 2 and 3, respectively. In general, the inertial particle focusing in the three channel designs followed quite similar tendency, but the introduced geometric asymmetry in the lower outer semicircle still produced slight difference among the three designs. FIG. 3d shows a more clear comparison on the focusing position and the width of the focusing streak for different particles in the three channels. For 15 μm microspheres, when Re_{c} increased from 10 to 40, the focusing streak shifted from 64-80.5 μm to 73.37-89.87 μm in Pattern 1; 63-79.5 μm to 69.25-85.75 μm in Pattern 2 and 63-78 μm to 64.5-79.5 μm in Pattern 3. As Pattern 3 has the largest radius of curvature for the lower outer semicircle, the produced Dean secondary flow was slightly weakened, also as indicated by Table 1. Therefore, the 15 μm microspheres were preferably focused near the centerline in Pattern 3 compared to the other two patterns. For 10 μm particles, they were not fully focused at Re_{c}=10. When Re, increased from 10 to 40, the focusing streak shifted from 73.3-99.5 μm to 83.5-96.8 μm in Pattern 1; 63.5-86.5 μm to 83.2-96.5 μm in Pattern 2 and 81.5-97.8 μm to 87.5-97.5 μm in Pattern 3. Therefore, Pattern 3 was the best design to separate 15 μm particles from 10 μm particles, as the edge-to-edge distance between the focused streaks of the two particles was the largest (at least 8 μm). FIG. 3c also shows that Pattern 3 was the only design in which the 15 μm and 10 μm particles flowed, respectively, into the middle outlet and the upper outlet at all the four Re_{c} values. For 7 μm particles, they switched from two streaks focusing (Re_{c}=10 and 20) to a single streak focusing (Re_{c}=30 and 40) in Pattern 1, as discussed previously. As the Dean secondary flow was weakened in Pattern 2 and 3, the 7 μm particles were not very effectively focused at Re_{c}=10 and 20. But they formed a single streak focusing at Re, =30 and 40 in Pattern 2 and 3. The focusing streak of 7 μm particles in the three patterns at Re_{c}=30 and 40 were nearly identical, occupying 99.8-107.8 μm along the cross-section. The rest three particles (5 μm, 3 μm, and 1 μm) behaved very similarly in the three channel patterns. The 5 μm particles formed two streaks focusing when Re_{c}>=20, occupying 101.8-108.8 μm (upper streak) and 21.2-29.3 μm (lower streak) of the cross-section. Similarly, the 3 μm particles formed two streaks focusing when Re_{c}>=20, occupying 94.8-108.8 μm (upper streak) and 22-30.8 μm (lower streak). The 1 μm particles could not be effectively focused in all the three channel patterns.

### Size-Based Inertial Particle Sorting

Having known the inertial focusing behaviors of individual particles with varying sizes in the three different patterns, channel Pattern 3 was chosen to demonstrate the sorting of a particle mixture of multiple particle sizes. To achieve high throughput, the flow rate of 197.60 μl/min (Re_{c}=40) was chosen for all the following sorting experiments. FIG. 4a shows the schematic experimental setup of the sorting of a particle mixture with 15 μm (green), 10 μm (red) and 3 μm (blue) fluorescent microparticles. The input particle mixture was sorted into three sub-populations collected by output 1, 2 and 3. FIG. 4b shows the differential focusing of the three particles at the trifurcated outlets after flowing through a series of wavy channel units. These fluorescent streaks explicitly indicated that the 15 μm (green) particles were primarily focused along the centerline of the main channel and collected in output 2. The 10 μm (red) particles were focused into a tight streak near the upper edge of the main channel, and thus collected in output 1. In the previous study of inertial focusing of individual particles, the edge-to-edge distance between the focusing streaks of 15 μm and 10 μm particles was around 8-10 μm. In this particle separation experiment, the distance between the focusing streaks of 15 μm and 10 μm particles was enlarged to around 30 μm, which greatly favored the particle sorting. The enlarged separation distance between 15 μm and 10 μm particles is likely attributed to the particle-particle interactive force at relatively high concentrations. When the larger 15 μm particles quickly occupied the middle region of the channel, these larger particles tended to repel smaller particles away from them. The smallest 3 μm (blue) particles were focused into two tight streaks close to the upper and lower edges of the main channel, and accordingly collected in both output 1 and 3.

### Size-Based Inertial Cell Sorting

The Pattern 3 inertial sorting device was used to separate breast cancer cells spiked in diluted whole blood samples, which aims to prove its potential clinical application in rare cell sorting. The whole blood sample was diluted 100 times using cell-free PBS buffer with a final concentration of 50 million cells per ml. The mixed cell samples contained ˜5% fluorescently stained breast cancer cells (MCF-7, diameters around 19-24 μm), which was evaluated by the fluorescence signal in the flow cytometric analyses. The rest cell populations in the cell mixture were mainly red blood cells (RBCs, diameters around 6-8 μm), platelets (diameters around 3 μm) and white blood cells (WBCs, diameters around 10-15 μm). FIG. 5a shows the microscopic image of the mixed cell sample, in which individual MCF-7 cells are much larger compared to other blood cells. A flow rate of 197.60 μl/min (Re_{c}=40) was conducted in order to achieve high throughput. According to the study of inertial focusing of individual particles in FIG. 3, it was expected that the MCF-7 cells would be collected in output 2, a majority of WBCs and RBCs would be collected in output 1, and platelets would be collected in both output 1 and 3, as shown in FIG. 5b.

The expected collection of different cell populations at the trifurcated outlets was verified through the sorting experiments presented in FIGS. 5c and 5d. FIG. 5c shows two major focusing streaks at the trifurcated outlets. Because of the relatively weak fluorescence in living cancer cells at high-speed flow rate, only a dim green streak could be visualized to represent its focusing position. The high density of RBCs (also including relatively lower amount of WBCs and platelets) even formed a focused dim red line without fluorescent labeling (the focusing streak of platelets near the lower edge of the channel could not be observed due to small size and low density). Obviously, upon a complete inertial focusing after flowing through a series of wavy channel units, breast cancer cells were concentrated along the centerline of main channel, and exhibited large separation distance from RBCs, WBCs and platelets. FIG. 5d even shows the separation process of an individual MCF-7 cell from other blood cells captured by a high-speed camera, in which a majority of blood cells flowed into output 1 and the larger MCF-7 cell (indicated by a white arrow) flowed into output 2.

The original cell mixture and sorted samples collected from the three outputs were analyzed using flow cytometer by counting at least 10,000 cells. FIG. 6a-6d shows the microscopic images of the original cell mixture and the three samples collected from outputs. The input sample contained fluorescently stained MCF-7 cells at a preset ratio of 5.3% with respect to whole blood cells. After the inertial sorting, almost all the MCF-7 cells were collected in output 2 as indicated by the concentrated green fluorescent spots in FIG. 6c. Output 1 collected a majority of unlabeled blood cells (FIG. 6b), and only a small portion of blood cells were collected in output 3 (FIG. 6d). To quantitatively evaluate the sorting performance, the recovery rate of MCF-7 cells (Eqn. 12) and purity of MCF-7 cells (Eqn. 13) in each output is defined.

$$\begin{matrix}Recovery rate = \frac{Number of cancer cells in each output}{Number of cancer cells in input} & ( 12 ) \\ Purity = \frac{Number of cancer cells in each output / inlet}{Total number of cells in each output / inlet} & ( 13 )\end{matrix}$$

After a single sorting process, it was able to recover 89.72% MCF-7 cells from the original input sample, as shown in FIG. 6f. Due to the inevitable cell-cell interactions at high cell concentrations, a small portion of MCF-7 cells were also collected from output 1 and 3, as indicated by the recovery rate of 3.56% and 2.18% in output 1 and 3, respectively. FIG. 6g shows the purity of MCF-7 cells in the three collected output samples after a single sorting process. The average purity of output 2 (isolated MCF-7 cells) is 68.9%, which has been enriched by 13 times from the original purity of 5.3%. The viability of MCF-7 cells collected from output 2 was studied. FIG. 6e shows that the sorted MCF-7 cells were able to proliferate, indicating excellent cell viability after the inertial sorting process.

In addition to the above, it should also be noted that liquid biopsy has emerged as a promising routine test in clinical diagnostic and prognostic detection due to its simple and non-invasive properties alternative to surgical biopsies, among which the circulating tumour cells (CTCs) and exosomes are quite appealing to researchers. The reason for exosomes becoming a rising star are: (I) comprehensive information contained from the metastatic carcinoma: exosomes, small membrane vesicles (30-200 nm) secreted by almost all cells, containing significant information as proteins, microRNAs and DNA, are closely associated with disease diagnostic and prognostic test in practice liquid biopsy; (II) abundant amount: compared with the rare amount of CTCs existing in patient's peripheral blood (10-100 CTCs per ml), exosomes have an edge in high concentration not only in peripheral blood, also appear in saliva, urine and synovial fluid etc., exhibiting more convenient platform for clinical sample obtention. However, traditional exosomes isolation methods usually are challenging to achieve outcomes with high-purity, high-throughput, low-cost, labour & time-saving process due to the super-small size of exosomes.

The present invention has shown to achieve sorting/separation/manipulation of the rare CTCs collection from heterogenous cell sample (shown in FIG. 7(I)) with particle diameters in micron level (particles>2 μm) utilizing the present inertial device.

Furthermore, the present invention realized exosomes collection from large vesicles (shown in FIG. 7(II)) with sub-micron diameters (or particles<2 μm). For obtention of exosomes, a series of reverse wavy channel structures combined viscoelastic fluids was presented for inertial submicron/nano-scale particles focusing and sorting. The microfluidic periodically reversed Dean secondary flow generated by wavy channel can facilitate particle focusing compared with straight channel. Larger extracellular vesicles are dominated by the elastic lift force and focus along the centreline region of the channel; while smaller exosomes will still remain the regions near the two side channel walls, therefore achieve the successfully exosome isolation.

### Effects of PEO Concentration for Various Submicron Particles

The elasto-inertial focusing behaviour of the four submicron particles (1 μm, 500 nm, 300 nm and 100 nm) under varying PEO concentrations in the wavy channel with a single inlet were investigated. FIG. 8 shows the particle focusing behavior at the trifurcated outlet with PEO concentration increased from 0.08 wt % to 0.16 wt %. 1 μm particles can achieve effective focusing with PEO concentration as low as 0.08 wt % and maintain similar focusing behavior as the PEO concentration increases to 0.16 wt %. 500 nm particles start to show the focusing tendency when PEO concentration is 0.08 wt % and exhibit better focusing as the PEO concentration increases. As indicated in eqn. 11, the elastic lift force scales with d³, which implies that the elastic lift force acting on the 1 μm particles is around 8 times of the force acting on the 500 nm particles under the same PEO concentration. As aforementioned according to Oldroyd-B model where N₁=2ηₚλ\dot{Υ}², in which the relaxation time λ of the PEO solution increases with c^{0.65} (c refers to PEO concentration), ηₚ increases with c and \dot{Υ} can be viewed as a constant⁷⁰ in PEO solutions at low concentrations, thus increasing c can enhance the elastic lift forces and also lead to further particle migration towards the centerline region⁷¹. 300 nm particles do not exhibit clear focusing behavior with PEO concentration at 0.08 wt % and 0.10 wt %, and gradually achieve effective focusing until the PEO concentration is increased higher than 0.14 wt %. 100 nm particles do not show any obvious focusing even when the PEO concentration is increased from 0.08 wt % to 0.16 wt %.

### Size-Based Inertial Sorting of Submicron Particles

Having known the elasto-inertial focusing behaviors of submicron particles in the wavy channel within viscoelastic fluids under various conditions, PEO concentration of 0.16 wt % was chosen to demonstrate size-based sorting of a particle mixture of 300 nm and 100 nm. Basically, the 100 nm and 300 nm particles were used to mimic the exosomes and larger EVs, respectively. The schematic experimental setup for the size-based sorting of the particle mixture is shown in FIG. 7(II), where the flow rates of the particle sample and sheath flow were 25 μl/min (equals to 1500 μl/h) and 150 μl/min (equals to 9000 μl/h), respectively. With the help of the sheath flow, the particles mixture were confined near the sidewalls when entering the main channel, and 300 nm particles gradually migrated to the central region and formed a tight streak along the centerline of the channel after flowing through a series of reverse wavy channel units. As explained previously, the lateral migration, i.e. elasto-inertial focusing, is dominated by the elastic lift force and facilitated by Dean flow. As observed from FIG. 8, 100 nm particles do not exhibit any focusing behavior and this implies that they just follow the main fluid flow and are confined near the channel wall by the sheath flow. As a result, 100 nm particles were collected from the side outlets and 300 nm particles were collected from the middle outlet to achieve separation of 100 nm from 300 nm particles. The collected two samples were analyzed by the NTA measurements, based on which FIG. 9 shows that after one single sorting process, the collection of 100 nm particles can achieve purity higher than 95% and recovery higher than 87.9%. The sorting experiments were separately repeated three times at the same conditions.

### Size-Based Inertial Sorting of Exosomes

To demonstrate the potential of this novel elasto-inertial sorting technique for exosome-related biological studies and clinical applications, the use of this technique to separate exosomes and larger EVs in MCF-7 culture medium was explored. The sorting conditions are exactly the same as the sorting of 100 nm and 300 nm particles in the previous section. Similar to the behavior of 300 nm particles, larger EVs gradually migrated to the central region and stayed focusing along the centerline of the channel after flowing through these repeated reverse wavy channel units, and eventually collected from the middle outlet. The smaller exosomes with a size between 30 and 200 nm remained near the side-walls and were collected from the two side outlets. The collected two samples were evaluated by NTA analysis. FIG. 10a shows the mixture distribution of exosomes (30-200 nm) and larger EVs (300-800 nm) from MCF-7 medium after normalization, in which the exosome concentration was almost 3.5 times more than larger EVs. FIGS. 10b and 10c represent the distribution of exosomes and larger EVs after the sorting procedure, respectively, exhibiting a great agreement with previous particle separation outcome. With the initial exosome concentration of 5×10⁸ particles/ml, high-throughput, size-based sorting of exosomes with purity higher than 88% and recovery higher than 76% after one single sorting process was successfully demonstrated, as shown in FIG. 10d. The sorting experiments were separately repeated three times at the same conditions.

### CONCLUSION

In summary, a new inertial focusing and sorting device with a series of reverse wavy channel structures that generate periodically reversed Dean secondary flow perpendicular to the main flow direction is presented. A balance between two inertial effects, inertial lift force and Dean secondary flow, produces size-dependent particle focusing across the channel. The inertial focusing behaviors of six particle sizes (15 μm, 10 μm, 7 μm, 5 μm, 3 μm and 1 μm) in three channel designs with different degrees of geometric asymmetry were studied. It has been found that when the inertial lift force dominated over the Dean drag force for 15 μm and 10 μm particles, they formed a single streak focusing. However, the different degree of force dominance for 15 μm and 10 μm particles still resulted in distinct particle focusing positions. As the particle size shrunk, the two forces became comparable for 7 μm particles that could switch from a single streak focusing to two streaks focusing at varying flow rates. When the Dean drag force dominated over the inertial lift force for 5 μm and 3 μm particles, they were focused into two tight streaks near the two sidewalls. Using the channel Pattern 3 device, the separation of 15 μm particles from 10 μm and 3 μm particles was demonstrated. As the minimum particle size for effective inertial focusing is between 1 μm and 3 μm in channel Pattern 3, the separation of MCF-7 cancer cells from diluted whole blood samples without the use of sheath flows was also demonstrated. It was found that a single sorting process was able to achieve 89.72% recovery rate of MCF-7 cells from the original mixture, and the purity of MCF-7 cells was significantly increased from 5.3% to 68.9%. Sorted MCF-7 cells showed excellent viability and was able to proliferate. Four differently sized fluorescent submicron spheres (1 μm, 500 nm, 300 nm and 100 nm) were used to study the focusing behavior within viscoelastic fluids under various conditions. With an optimized parameters combination, the present invention has demonstrated high throughput (dozens of microliters per min, thousands of microliters per hour) size-dependent and label-free sorting of exosomes with purity higher than 88% and recovery higher than 76%. The linear array of these repeated wavy channel units enables easy horizontal (2D) and vertical (3D) parallelization of multiple channels, which provides great potential of high-throughput cell sorting in practical biomedical applications.

The key advantage/improvement over existing methods is that the present inertial microfluidic devices provide a very low cost platform for high throughput and high fidelity cell sorting based on their sizes. The only component in this system that requires power actuation is the pump for sample introduction at high flow rates. Since the cost of the inertial microfluidic device is much lower than conventional microfluidic devices with complex actuators, these inertial device can be afforded for single use to avoid cross-contamination.

Whilst there has been described in the foregoing description preferred embodiments of the present invention, it will be understood by those skilled in the technology concerned that many variations or modifications in details of design or construction may be made without departing from the present invention.

### REFERENCES

1. Petersson F, Åberg L, Swärd-Nilsson A-M, Laurell T. Free Flow Acoustophoresis: Microfluidic-Based Mode of Particle and Cell Separation. Anal Chem. 2007; 79(14):5117-5123. doi:10.1021/ac070444e
2. Mulvana H, Cochran S, Hill M. Ultrasound assisted particle and cell manipulation on-chip. Adv Drug Deliv Rev. 2013; 65(11-12):1600-1610. doi:10.1016/j.addr.2013.07.016
3. Destgeer G, Ha B H, Park J, Jung J H, Alazzam A, Sung H J. Microchannel anechoic corner for size-selective separation and medium exchange via traveling surface acoustic waves. Anal Chem. 2015; 87(9):4627-4632. doi:10.1021/acs.analchem.5b00525
4. Ma Z, Collins D J, Ai Y. Single-actuator Bandpass Microparticle Filtration via Traveling Surface Acoustic Waves. Colloid Interface Sci Commun. 2017; 16:6-9. doi:10.1016/j.colcom.2016.12.001
5. Collins D J, Ma Z, Han J, Ai Y. Continuous micro-vortex-based nanoparticle manipulation via focused surface acoustic waves. Lab Chip. 2017; 112(1):4469-4506. doi:10.1039/C6LC01142J
6. Kralj J G, Lis M T W, Schmidt M A, Jensen K F. Continuous dielectrophoretic size-based particle sorting. Anal Chem. 2006; 78(14):5019-5025. doi:10.1021/ac0601314
7. Zhu J, Tzeng T R J, Xuan X. Continuous dielectrophoretic separation of particles in a spiral microchannel. Electrophoresis. 2010; 31(8):1382-1388. doi:10.1002/elps.200900736
8. Jubery T Z, Srivastava S K, Dutta P. Dielectrophoretic separation of bioparticles in microdevices: A review. Electrophoresis. 2014; 35(5):691-713. doi:10.1002/elps.201300424
9. Voldman J. Electrical Forces for Microscale Cell Manipulation. Annu Rev Biomed Eng. 2006; 8(1):425-454. doi:10.1146/annurev.bioeng.8.061505.095739
10. Park S, Koklu M, Beskok A. Particle trapping in high-conductivity media with electrothermally enhanced negative dielectrophoresis. Anal Chem. 2009; 81(6):2303-2310. doi:10.1021/ac802471g
11. Hejazian M, Li W, Nguyen N-T, et al. Lab on a chip for continuous-flow magnetic cell separation. Lab Chip. 2015; 15(4):959-970. doi:10.1039/C4LC01422G
12. Miltenyi S, Müller W, Weichel W, Radbruch A. High gradient magnetic cell separation with MACS. Cytometry. 1990; 11(2):231-238. doi:10.1002/cyto.990110203
13. Murray C, Pao E, Tseng P, et al. Quantitative Magnetic Separation of Particles and Cells Using Gradient Magnetic Ratcheting. Small. 2016. doi:10.1002/sm11.201502120
14. Morton K J, Loutherback K, Inglis D W, et al. Hydrodynamic metamaterials: microfabricated arrays to steer, refract, and focus streams of biomaterials. Proc Natl Acad Sci USA. 2008; 105(21): 7434-7438. doi:10.1073/pnas.0712398105
15. Choi S, Ku T, Song S, Choi C, Park J-K. Hydrophoretic high-throughput selection of platelets in physiological shear-stress range. Lab Chip. 2011; 11:413-418. doi:10.1039/c01c00148a
16. Huang L R. Continuous Particle Separation Through Deterministic Lateral Displacement. Science (80-). 2004; 304(5673):987-990. doi:10.1126/science.1094567
17. Chen Y, Li P, Huang P-H, et al. Rare cell isolation and analysis in microfluidics. Lab Chip. 2014; 14(4):626-645. doi:10.1039/c3lc90136j
18. Inglis D W, Davis J a, Austin R H, Sturm J C. Critical particle size for fractionation by deterministic lateral displacement. Lab Chip. 2006; 6(5):655-658. doi:10.1039/b515371a
19. Segré G S A. Radial particle displacements in Poiseuille flow of suspensions.

Nature. 1961; 189:209-10.
20. Di Carlo D, Irimia D, Tompkins R G, Toner M. Continuous inertial focusing, ordering, and separation of particles in microchannels. Proc Natl Acad Sci USA. 2007; 104(48):18892-18897. doi:10.1073/pnas.0704958104
21. Martel J M, Toner M. Inertial focusing in microfluidics. Annu Rev Biomed Eng. 2014; 16:371-396. doi:10.1146/annurev-bioeng-121813-120704
22. Zhang J, Yan S, Yuan D, et al. Fundamentals and Applications of Inertial Microfluidics: A Review. Lab Chip. 2016; 16:10-34. doi:10.1039/C5LC01159K
23. Amini H, Lee W, Di Carlo D. Inertial microfluidic physics. Lab Chip. 2014; 14(15):2739-2761. doi:10.1039/c41c00128a
24. Zhou J, Papautsky I. Fundamentals of inertial focusing in microchannels. Lab Chip. 2013; 13(6):1121-1132. doi:10.1039/c21c41248a
25. Choi Y-S, Seo K-W, Lee S-J. Lateral and cross-lateral focusing of spherical particles in a square microchannel. Lab Chip. 2011; 11(3):460-465. doi:10.1039/c01c00212g
26. Mach A J, di Carlo D. Continuous scalable blood filtration device using inertial microfluidics. Biotechnol Bioeng. 2010; 107(2):302-311. doi:10.1002/bit.22833
27. Bhagat A A S, Kuntaegowdanahalli S S, Papautsky I. Inertial microfluidics for continuous particle filtration and extraction. Microfluid Nanofluidics. 2009; 7(2):217-226. doi:10.1007/s10404-008-0377-2
28. Zhang J, Yan S, Sluyter R, Li W, Alici G, Nguyen N-T. Inertial particle separation by differential equilibrium positions in a symmetrical serpentine micro-channel. Sci Rep. 2014; 4(ii):4527. doi:10.1038/srep04527
29. Di Carlo D, Edd J F, Irimia D, Tompkins R G, Toner M. Equilibrium separation and filtration of particles using differential inertial focusing. Anal Chem. 2008; 80(6):2204-2211. doi:10.1021/ac702283m
30. Oakey J, Applegate R W, Arellano E, Carlo D Di, Graves S W, Toner M. Particle focusing in staged inertial microfluidic devices for flow cytometry. Anal Chem. 2010; 82(9):3862-3867. doi:10.1021/ac100387b
31. Özbey A, Karimzadehkhouei M, Akgönül S, Gozuacik D, Koşar A. Inertial Focusing of Microparticles in Curvilinear Microchannels. Sci Rep. 2016; 6(November):1-11. doi:10.1038/srep38809
32. Ozkumur E, Shah A M, Ciciliano J C, et al. Inertial focusing for tumor antigen-dependent and -independent sorting of rare circulating tumor cells. Sci Transl Med. 2013; 5(179):179ra47. doi:10.1126/scitranslmed.3005616
33. Kotz K T, Petrofsky A C, Haghgooie R, Granier R, Toner M T R. Inertial focusing cytometer with integrated optics for particle characterization. Technology. 2013; 1:27-36.
34. Tanaka T, Ishikawa T, Numayama-Tsuruta K, et al. Separation of cancer cells from a red blood cell suspension using inertial force. Lab Chip. 2012; 12(21):4336-4343. doi:10.1039/c2lc40354d
35. Sun J, Li M, Liu C, et al. Double spiral microchannel for label-free tumor cell separation and enrichment. Lab Chip. 2012; 12(20):3952. doi:10.1039/c2lc40679a
36. Nivedita N, Papautsky I. Continuous separation of blood cells in spiral microfluidic devices. Biomicrofluidics. 2013; 7(5). doi:10.1063/1.4819275
37. Lee M G, Choi S, Park J K. Inertial separation in a contraction-expansion array microchannel. J Chromatogr A. 2011; 1218(27):4138-4143. doi:10.1016/j.chroma.2010.11.081
38. Sollier E, Go D E, Che J, et al. Size-selective collection of circulating tumor cells using Vortex technology. Lab Chip. 2014; 14(1):63-77. doi:10.1039/c31c50689d
39. Hur S C, Mach A J, Di Carlo D. High-throughput size-based rare cell enrichment using microscale vortices. Biomicrofluidics. 2011; 5(2). doi:10.1063/1.3576780
40. Mach A J, Kim J H, Arshi A, Hur S C, Di Carlo D. Automated cellular sample preparation using a Centrifuge-on-a-Chip. Lab Chip. 2011; 11(17):2827-2834. doi:10.1039/C1LC20330D
41. W R D. Fluid motion in a curved channel. Proc R Soc A Math Phys Eng Sci. 1928; 121:402-20.
42. Di Carlo D, Edd J F, Humphry K J, Stone H A, Toner M. Particle segregation and dynamics in confined flows. Phys Rev Lett. 2009; 102(9):1-4. doi:10.1103/PhysRevLett.102.094503
43. Bhagat A A S, Kuntaegowdanahalli S S, Kaval N, Seliskar C J, Papautsky I. Inertial microfluidics for sheath-less high-throughput flow cytometry. Biomed Microdevices. 2010; 12(2):187-195. doi:10.1007/s10544-009-9374-9
44. Wu L, Guan G, Hou H W, Bhagat A A S, Han J. Separation of leukocytes from blood using spiral channel with trapezoid cross-section. Anal Chem. 2012; 84(21):9324-9331. doi:10.1021/ac302085y
45. Kuntaegowdanahalli S, Bhagat A. Inertial microfluidics for continuous particle separation in spiral microchannels. Lab Chip. 2009; 9(20):2973-2980. doi:10.1039/b908271a
46. Hur S C, Henderson-MacLennan N K, McCabe E R B, Di Carlo D. Deformability-based cell classification and enrichment using inertial microfluidics. Lab Chip. 2011; 11(5):912. doi:10.1039/c01c00595a
47. Bhagat A A S, Hou H W, Li L D, Lim C T, Han J. Pinched flow coupled shear-modulated inertial microfluidics for high-throughput rare blood cell separation. Lab Chip. 2011; 11(11):1870-1878. doi:10.1039/c01c00633e
48. Faivre M, Abkarian M, Bickraj K, Stone H a. Geometrical focusing of cells in a microfluidic device: an approach to separate blood plasma. Biorheology. 2006; 43(2):147-159. doi:10.1016/j.ympev.2009.02.016
49. Gossett D R, Tse H T K, Dudani J S, et al. Inertial manipulation and transfer of microparticles across laminar fluid streams. Small. 2012; 8(17):2757-2764. doi:10.1002/sm11.201200588
50. Racila E, Euhus D, Weiss A J, et al. Detection and characterization of carcinoma cells in the blood. Proc Natl Acad Sci USA. 1998; 95(8):4589-4594.
51. Warkiani M E, Guan G, Luan K B, et al. Slanted spiral microfluidics for the ultra-fast, label-free isolation of circulating tumor cells. Lab Chip. 2014; 14(1):128-137. doi:10.1039/c31c50617g
52. Hou H W, Warkiani M E, Khoo B L, et al. Isolation and retrieval of circulating tumor cells using centrifugal forces. Sci Rep. 2013; 3:1259. doi:10.1038/srep01259
53. Edd J F, Di Carlo D, Humphry K J, et al. Controlled encapsulation of single cells into monodisperse picoliter drops. Lab Chip. 2008; 8(8):1262-1264. doi:10.1039/b805456 h
54. Warkiani M E, Khoo B L, Wu L, et al. Ultra-fast, label-free isolation of circulating tumor cells from blood using spiral microfluidics. Nat Protoc. 2016; 11(1):134-148. doi:10.1038/nprot.2016.003
55. Kim J, Lee J, Wu C, et al. Inertial focusing in non-rectangular cross-section microchannels and manipulation of accessible focusing positions. Lab Chip. 2016; 16(6):992-1001. doi:10.1039/C5LC01100K
56. Asmolov E S. The inertial lift on a spherical particle in a plane Poiseuille flow at large channel Reynolds number. J Fluid Mech. 1999; 381(1999):63-87. doi:10.1017/S0022112098003474
57. Gyves T W, Irvine T F. Laminar conjugated forced convection heat transfer in curved rectangular channels. Int J Heat Mass Transf. 2000; 43(21):3953-3964. doi:10.1016/S0017-9310(00)00041-7
58. D'Avino G, Greco F, Maffettone P L. Particle Migration due to Viscoelasticity of the Suspending Liquid and Its Relevance in Microfluidic Devices. Annu Rev Fluid Mech. 2017; 49(1):341-360. doi:10.1146/annurev-fluid-010816-060150
59. D'Avino G, Maffettone P L. Particle dynamics in viscoelastic liquids. J Nonnewton Fluid Mech. 2015; 215:80-104. doi:10.1016/j.jnnfm.2014.09.014
60. Yuan D, Zhao Q, Yan S, et al. Recent progress of particle migration in viscoelastic fluids. Lab Chip. 2018; 18(4):551-567. doi:10.1039/c71c01076a
61. Huang P Y, Feng J, Hu H H, Joseph D D. Direct simulation of the motion of solid particles in Couette and Poiseuille flows of viscoelastic fluids. J Fluid Mech. 1997; 343:73-94. doi:10.1017/S0022112097005764
62. Ho B P, Leal L G. Migration of rigid spheres in a two-dimensional unidirectional shear flow of a second-order fluid. J Fluid Mech. 1976; 76(4):783-799. doi:10.1017/5002211207600089X
63. Bird R B, Armstrong R C, Hassager O. Dynamics of polymeric liquids. John Wily sons Inc. 1987; 1:672. doi:10.1002/pol.1987.140251210
64. Villone M M, D'Avino G, Hulsen M A, Greco F, Maffettone P L. Particle motion in square channel flow of a viscoelastic liquid: Migration vs. secondary flows. J Nonnewton Fluid Mech. 2013; 195:1-8. doi:10.1016/j.jnnfm.2012.12.006
65. Pathak J A, Ross D, Migler K B. Elastic flow instability, curved streamlines, and mixing in microfluidic flows. Phys Fluids. 2004; 16(11):4028-4034. doi:10.1063/1.1792011
66. Barnes H A, Hutton J F. Chapter 2: Viscosity. In: An Introduction to Rheology.; 1989:11. doi:http://dx.doi.org/10.1016/B978-0-444-87469-6.50006-8
67. Leshansky A M, Bransky A, Korin N, Dinnar U. Tunable nonlinear viscoelastic “focusing” in a microfluidic device. Phys Rev Lett. 2007; 98(23). doi:10.1103/PhysRevLett.98.234501
68. Tehrani M A. An experimental study of particle migration in pipe flow of viscoelastic fluids. J Rheol (NY N.Y.). 1996; 40(6):1057-1077. doi:10.1122/1.550773
69. Lu X, Liu C, Hu G, Xuan X. Particle manipulations in non-Newtonian microfluidics: A review. J Colloid Interface Sci. 2017; 500:182-201. doi:10.1016/j.jcis.2017.04.019
70. Liu C, Guo J, Tian F, et al. Field-Free Isolation of Exosomes from Extracellular Vesicles by Microfluidic Viscoelastic Flows. ACS Nano. 2017; 11(7):6968-6976. doi:10.1021/acsnano.7b02277
71. Tian F, Zhang W, Cai L, et al. Microfluidic co-flow of Newtonian and viscoelastic fluids for high-resolution separation of microparticles. Lab Chip. 2017; 17(18):3078-3085. doi:10.1039/c7lc00671c

1. A device for sorting, separating or manipulating particles in a fluid suspension, the device comprising:
(a) at least one inlet for introducing the fluid suspension;
(b) at least one outlet for discharging the fluid suspension containing particles of a desired size; and
(c) a channel in fluid communication with and intermediate to the at least one inlet and the at least one outlet, a portion of the channel is curved to form at least one curved unit, the curved unit is shaped to form a profile of a wave having a crest, a lip that curls over a trough, and a face,
wherein the crest, lip, face and trough of the curved unit each forms a semicircular arc segment, the fluid suspension travels through the curved unit from the semicircular arc segment of the crest to the semicircular arc segment of the trough.

2. The device according to claim 1, wherein the diameter of the semicircular arc segment of the trough is equal to or greater than the diameter of the semicircular arc segment of the crest.

3. The device according to claim 2, wherein the diameter of the semicircular arc segment of the trough is between 200 μm to 1200 μm.

4. The device according to claim 1, wherein the channel comprises a plurality of curved units.

5. The device according to claim 4, wherein the plurality of curved units are arranged in a linear direction.

6. The device according to claim 4, wherein the plurality of curved units comprises between 10 to 40 curved units.

7. The device according to claim 1, wherein the at least one outlet further comprises three outlets, a first, second and third outlet.

8. The device according to claim 1, wherein the widths of the first, second and third outlets are different.

9. The device according to claim 8, wherein the width of the first, second and third outlets are 30-80 μm, 40-55 μm and 30-80 μm respectively.

10. The device according to claim 1, wherein the main channel has a rectangular cross-section profile.

11. (canceled)

12. The device according to claim 1, wherein each of the inlet and the at least one outlet further comprises a reservoir, the diameter of the reservoir is 1.5 mm.

13. The device according to claim 1, wherein the diameter of the semicircular arc segment of the crest is between 600 to 800 μm, the diameter of the semicircular arc segment of the face is between 200 to 350 μm, the diameter of the semicircular arc segment of the lip is between 200 to 350 μm, and the diameter of the semicircular arc segment of the trough is between 600 μm to 1200 μm.

14. A method for sorting, separating or manipulating particles in a fluid suspension, the method comprising:
(a) providing at least one inlet for introducing the fluid suspension;
(b) providing at least one outlet for discharging the fluid suspension containing particles of a desired size;
(c) a main channel in fluid communication with and intermediate to the at least one inlet and the at least one outlet, a portion of the main channel is curved to form at least one curved unit, the curved unit is shaped to form a profile of a wave having a crest, a lip that curls over a trough, and a face, wherein the crest, lip, face and trough of the curved unit each forms a semicircular arc segment; and
(d) pumping the fluid suspension through the curved unit from the semicircular arc segment of the crest to the semicircular arc segment of the trough.

15. The method according to claim 14, further comprising pumping the fluid suspension through the curved unit wherein the diameter of the semicircular arc segment of the trough is equal to or greater than the diameter of the semicircular arc segment of the crest.

16. The method according to claim 14, further comprising pumping the fluid suspension through a plurality of curved units that are arranged in a linear direction, the plurality of curved units comprises between 10 to 40 curved units.

17. The method according to claim 14, further comprising pumping the fluid suspension at a flow rate of between 40 μl/min to 200 μl/min.

18. (canceled)

19. The method according to claim 14, further comprising discharging the fluid suspension in three outlets, a first, second and third outlet.

20. The method according to claim 19, further comprising discharging the fluid suspension containing particles having a size of about 3 μm to 10 μm at the first outlet, discharging the fluid suspension containing particles having a size of about 15 μm at the second outlet, and discharging the fluid suspension containing particles having a size of about 3 μm at the third outlet.

21. The method according to claim 14, wherein the fluid suspension is a whole blood sample and the method separates cancer cells from the sample, separate different types of blood cells or separate submicron vesicles and exosomes from the fluid suspension sample.

22. The method according to claim 14, wherein the method separates particles having a size of about 300 nm from particles having a size of about 100 nm.

23. (canceled)
